(19) United States
(12) Patent Application Publication
(10) Pub. No.: US 2017/0185957 A1
(43) Pub. Date: Jun. 29, 2017

(54) SYSTEM AND METHOD FOR VALIDATING STORAGE OR SHIPMENT OF ENVIRONMENTALLY SENSITIVE PRODUCTS OR ITEMS

(71) Applicant: Richard A.C. KILMER, Reston, VA (US)

(72) Inventor: Richard A.C. KILMER, Reston, VA (US)

(21) Appl. No.: 15/309,414

(22) PCT Filed: May 7, 2015
(86) PCT No.: PCT/US15/29791

§ 371 Date: Nov. 7, 2016

Related U.S. Application Data
(60) Provisional application No. 61/990,722, filed on May 9, 2014.

(51) Int. Cl. G06Q 10/08; H04L 9/14; H04L 9/30; H04W 4/00

(52) U.S. Cl. CPC G06Q 10/0832; H04W 4/008; H04L 9/14; H04L 9/30; H04L 63/06

(57) ABSTRACT

A method and system to validate that storage and/or shipment of products or items that are sensitive to environmental conditions such as temperature, exposure to light, vibration, etc., which affect the efficacy and/or projected expiration date of the products or items, complies with environmental requirements for the stored and/or shipped products or items.

### FIELD

The present invention relates generally to storage and shipment of products or items that are sensitive to environmental conditions such as temperature, exposure to light, vibration, etc., which affect the efficacy and/or projected expiration date of the products or items, and validation of chain of custody during shipment.

### BACKGROUND

Recent laws enacted in the United States such as the Drug Quality and Security Act of 2013 (“DQSA”) now require each pharmaceutical product sold to have a unique identifier associated to the product to verify its authenticity. Under this law, the identifiers that are required on pharmaceutical products include:

a drug's national drug code

a unique serial number

a lot number

an expiration date.

One of the key requirements of the law is to build an infrastructure (databases, etc.) that may be used by participants in the pharmaceutical supply chain to query for these identifiers and authenticate a product during storage or shipment prior to pharmacy distribution. The goal of the DQSA is to prevent counterfeit drugs from being transported or sold in the US. The law does not focus on whether a pharmaceutical product is usable except for the inclusion of an expiration date with the other identifiers. The expiration date is a date that the manufacturer has calculated after which the pharmaceutical product is no longer efficacious or deemed suitable for use.

In general, to calculate the expiration date, the manufacturer must assume a product or item is maintained in a recommended environment for the expiration date to be valid according to manufacturer specifications, that is, for the expiration date value to be true. For many products, that environment is Controlled Room Temperature (CRT) or 15° C.-25° C. Many other products or items require a refrigerated (2° C.-8° C.) or frozen (<−20° C.) environment to prevent premature expiration.

Additionally, there are other environmental conditions that can affect the efficacy or suitability for use of a product or item, including exposure to light, humidity, shock, or vibration or a combination of these environmental conditions. Because all products and items are typically moved through different environments along a supply chain and every product or item is potentially subject to some extreme of environmental conditions that affect their efficacy or suitability for use, the expiration date should be considered a variable instead of a fixed date.

### SUMMARY

In accordance with the present invention, various examples of a system and method for authentication and/or validation of environmentally sensitive products and items are provided. By way of one non-limiting example in accordance with the present invention, a system and method are provided to enable environmental specifications for a product or item to be associated to the product or item by the use of a tag affixed to the product or item. By way of a non-limiting example, the tag may be an electronic device comprising memory to store the environmental specifications. The tag also comprises a transmitter coupled to the memory, and the environmental specifications may be communicated, for example, by wireless transmission, so that provisions for storage and/or shipment of the tagged product or item may be provided to assure compliance with the environmental specifications for the product or item. In one non-limiting example, the tag communicates via a Bluetooth Low Energy (BLE) chipset.

By way of another non-limiting example in accordance with the present invention, a system and method are provided to enable a tag having environmental specifications associated with a product or item to be stored and/or shipped and tags for storage or shipping containers having specifications for dimensions and thermal properties. The tags communicate with each other, for example, by wireless transmission, so that provisions for storage and/or shipment of the tagged product or item are compatible with the tagged storage and/or shipping containers to ensure compliance with the requirements of the environmental specifications for the product or item being stored and/or shipped. By way of a further non-limiting example in accordance with the present invention, a refrigerant unit and/or an insulator unit may be combined with a storage and/or shipping container. The refrigerant unit or insulator unit is provided with a tag having specifications for thermal properties. The tags communicate with each other, for example, by wireless transmission, so that provisions for storage and/or shipment of the tagged product or item is compatible with the tagged storage and/or shipping containers incorporating the tagged refrigerant unit and/or insulator unit to assure compliance with the requirements of the environmental specifications for the product or item being stored and/or shipped. In one non-limiting example, the tags communicate via Bluetooth Low Energy (BLE) chipsets.

By way of a further non-limiting example in accordance with the present invention, a system and method are provided to enable tags having environmental specifications to be associated with a product or item to be stored and/or shipped and tags for storage or shipping containers having specifications for dimensions and thermal properties. Additionally, a sensor is provided on at least one of the product or item and/or the storage and/or shipping containers to measure environmental conditions during storage and/or shipment and comprises a transmitter to communicate, for example, by wireless transmission, and/or store the measurements in memory comprising the sensor. Consequently, the environmental conditions may be measured and monitored to validate whether or not the environmental conditions encountered during storage and/or shipment are within the specified range of environmental conditions for the product or item being stored and/or shipped. In accordance with another non-limiting example, the environmental conditions may be measured and communicated wirelessly to be updated and analyzed by an external device based on the measured environmental conditions of the container(s) in which the product or item is contained throughout the supply chain from manufacturing to distribution.

By way of yet another non-limiting example in accordance with the present invention, identifying information stored in the memory of the product or item tag comprises a lot number and serial number(s), for example, as required by the DQSA. In addition, a public key (of a public/private key pair) of the manufacturer is stored in the memory of the product or item tag and is accessible to be read. The private key (of the public/private key pair) is used to digitally encrypt the lot/serial numbers and store the encrypted data in the memory of the product or item tag with the lot/serial number(s) stored in the tag memory. During shipment, when a custody transfer occurs, the original lot/serial numbers are transmitted by a device, which is in wireless communication with each product or item tag, to a server for the assuming (i.e., receiving party), who is required to encrypt the lot/serial numbers with their private key (of a public/private key pair) and their public key is transmitted back to the device along with the encrypted lot/serial numbers, which updates the product or item tag with a change of custody Assume Event (public key plus encrypted lot/serial numbers). The releasing party in the change of the chain of custody transfer uses a separate device, which is in wireless communication with each product or item tag, to read the public key of the assuming party from the product or item tag and sends that public key to a server for the releasing party, who is required to encrypt with their private key (of a public/private key pair) the assuming party's public key, which is transmitted back to the separate device to update the product or item tag with a change of custody Release Event (encrypted public key of the assuming party). Each party that accepts a transfer of custody performs this procedure. Upon receipt at the end point (e.g., a pharmacy, hospital, doctor's office, etc.) the sequence of change of custody events can be analyzed to validate that the product or item has been in a proper chain of custody throughout the supply chain process. Storing the change of custody events in the memory of the product or item tag enables validation of chain of custody without need of a central database.

Advantageously, the various examples in accordance with the present invention not only enable products or items to be authenticated, for example, in accordance with the DQSA, but also enable compliance with environmental specifications for the products or items to be validated. These two principles, taken together, create the basis for a safe (authenticated) distribution of efficacious (validated) drugs, for example.

With annual losses in the tens of billions of dollars in the pharmaceutical industry, a system and method in accordance with the various examples of the present invention may be utilized to substantially reduce those losses. Yet, the cost of the system and method would be orders of magnitude less than the resulting savings, both in terms of monetary losses and in manpower used to store and ship products or items that are sensitive to environmental conditions.

### BRIEF DESCRIPTION OF DRAWINGS

The various examples of the present invention will be described in conjunction with the accompanying figures of the drawing to facilitate an understanding of various examples in accordance with the present invention. In the drawing:

FIG. 1 is illustrates an example of association of a tag with a product or item and a sensor with a container in which the product or item is stored and/or shipped in accordance with the present invention.

FIG. 2 is a flow diagram of an example of a method for self-validation of a product or item in accordance with the present invention.

FIG. 3 is a flow diagram of an example of a method for validation of storage of a product or item in accordance with the present invention.

FIG. 4 is a flow diagram of an example of a method for validation of shipment of a product or item in accordance with the present invention.

FIG. 5 is a block diagram of an example of a system for communication of specifications among tags and communication of measurements by sensors during shipment in accordance with the present invention.

FIG. 6 is a block diagram of a Bluetooth radio transmitter;

FIG. 7 is a block diagram of a digital Bluetooth receiver;

FIG. 8 is an example of an external device that may communicate with the tags and sensors shown in FIG. 5.

FIG. 9 is a block diagram of a network for communication with the tags and sensors and external devices shown in FIGS. 5 and 8.

FIG. 10 is a flow diagram of an example of a method for validation of a chain of custody for a product or item in accordance with the present invention.

### DESCRIPTION OF EMBODIMENTS

Some portions of the following detailed description are presented in terms of algorithms and symbolic representations of operations on data bits within a computer memory. These algorithmic descriptions and representations are the means used by persons skilled in the data processing art to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

The present invention, in some examples, also relates to apparatus for performing the operations discussed herein. This apparatus may be specially constructed for the required purposes, or it may comprise a general purpose computer selectively activated or reconfigured by a computer program comprising code segments stored in the computer. Such a computer program may be stored in a computer-readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the various examples of the present invention are not described with reference to any particular programming language, and various examples may thus be implemented using a variety of programming languages. Persons skilled in the art will appreciate that although specific examples and embodiments of the system and methods have been described for purposes of illustration, various modifications can be made without deviating from present invention. For example, examples in accordance with the present invention may be applied to many different types of databases, systems, and application programs. Moreover, features of one example may be incorporated into other examples, even where those features are not described together in a single example within the present document.

A Bluetooth Low Energy (Bluetooth 4.0) device hereafter referred to as “BLE” operates a wireless transmitter comprising the device at a low power level. A single watch battery can power a BLE wireless transmitter for several years broadcasting data at a rate of three (3) times per second. A key element of the BLE standard is the inclusion of an attribute protocol. In prior versions of Bluetooth, there was a set of fixed types of devices. In accordance with the Bluetooth 4.0 standard, a wide variety of types of Services are provided based on a Universally Unique Identifier (UUID) for each Service. Each Service is composed of a set of Characteristics or attributes. A Characteristic or attribute may be a simple value that is read and written, such as a value stored on a computer disk. A Characteristic or attribute may alternatively be a reading that is internally computed and returned but is not writeable. Additionally, a Characteristic or attribute may be an actuator that, when written, adjusts a behavior or setting (e.g., turn a light on or off). All Characteristics or attributes, when combined, define the behavior of the Service. Each Characteristic is identified by its UUID.

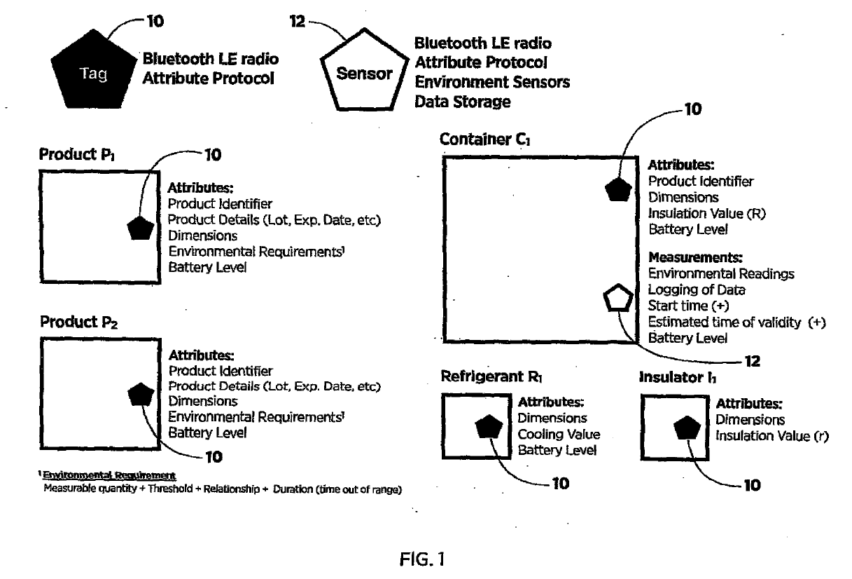

By way of a non-limiting example in accordance with the present invention, a tag 10 shown in FIG. 1 may be a BLE device that includes a basic Service with Characteristics or attributes that can be written and read. The tag 10 comprises a BLE transmitter, amplifier, antenna, memory, and battery. The tag 10 is packaged in a small, rugged plastic enclosure that is adapted to be attached to a product or item in fixed relationship to the product or item so that the tag is verifiably associated to the product or item. By way of a further non-limiting example, a shared cryptographic key (password) may be required to read or write Characteristics or attributes if those values, transmitted openly, would otherwise compromise the security of the product or item to which the tag is affixed.

By way of an additional non-limiting example in accordance with the present invention, a sensor 12 may be additionally provided. The sensor 12 is composed of a BLE device that comprises all the capabilities of a tag. Additionally, the sensor further comprises elements to measure environmental conditions such as temperature, light exposure, barometric pressure, humidity, shock, tilt, vibration, etc. The sensor 12 is used to measure environmental conditions encountered by a storage and/or shipping container in which a product or item is stored and/or transported. Collectively these environmental conditions may be read via Characteristics or attributes by an external device communicating by wireless transmission with the BLE device as will be described in more detail below. By way of another non-limiting example, the sensor 12 may comprise sufficient memory to record time-stamped readings over time, which may be transferred (via Characteristics or attributes) by wireless transmission to the external device. By way of a still further non-limiting example, the sensor 12 may be provided with sufficient data processing capability to be used to interact with and adjust the expiration date of tags 10 associated with products or items based on measured environmental conditions.

By way of a non-limiting example in accordance with the present invention, when a product or item is stored or shipped, the individual product or item P1 or P2 shown in FIG. 1 is paired with a tag 10 affixed to the product or item. In a non-limiting example in which the products or items P1 and P2 are pharmaceuticals that must comply with DQSA, the Characteristics or attributes that are preferably stored in memory comprising the tag 10 include:

National Drug Code

Serial Number

Lot Number

Expiration Date

Dimensions of the product (length, width, height, mass, weight)

One or more environmental requirements

An environmental requirement may be either an individual measurable parameter (e.g., temperature, light intensity, humidity, pressure, vibration, etc.) or a composite value that includes a measurable parameter, a threshold (e.g., 25° C.), a relationship (i.e., greater than, less than, equal to), and a duration (e.g., 10 minutes). An individual or composite environmental requirement creates a boundary that if reached or crossed (excursion) may modify or negate the expiration date of the product or item.

The relationship between an environmental requirement respecting the expiration date may be a simple computation (e.g., if temperature is greater than 25° C. for less than 10 minutes, expiration date=expiration date−20%*(expiration date−current date)) or by a relationship defined by an algorithm using one or more measurable parameters (e.g., if temperature is greater than 25° C. for greater than 10 minutes and humidity is greater than 75%, expiration date=expiration date*0% (product destroyed and expiration date negated)). The computation or algorithm may be included as an additional environmental requirement or be accessed through a central database of effects using an external device in communication with the tag 10 and sensor 12 as will be described below.

By way of a further non-limiting example in accordance with the present invention, a storage and/or shipping container C1 for the products or items P1 and P2 may include a tag 10, as shown in FIG. 1. Characteristics or attributes stored in the tag 10 affixed to the container C1 preferably include:

Container details (container manufacturer, materials, etc.)

Exterior and interior dimensions of the container (length, width, height, mass, weight)

Insulation value (R) of the container for heat transfer computations.

Additionally, as shown in FIG. 1, a refrigerant unit R1 may be provided for refrigerated storage and/or shipment of the products P1 and P2 in the container C1. The refrigerant unit R1 is also preferably provided with a tag 10. The refrigerant unit R1 has a certain associated cooling value specification. Refrigerants transfer heat until thermal equilibrium is achieved. Some refrigerants undergo a phase transition as part of the heat transfer during the establishment of thermal equilibrium within a refrigerated container C1 (e.g., dry ice). Establishment of thermal equilibrium occurs within the refrigerated container C1 for the products or items P1 and P2 placed in the container with the refrigerant unit R1. Affixing a tag 10 to the refrigerant unit R1 enables the properties of the refrigerant unit to be included in computations respecting validation of a stored and/or shipped product or item. The Characteristics or attributes for the properties of a refrigerant unit R1 stored in the tag 10 for use in temperature-controlled storage and/or shipping preferably include:
Refrigerant unit details (refrigerant unit manufacturer, materials, etc.)
Exterior and interior dimensions of the refrigerant unit (length, width, height, mass, weight)
Refrigerant properties and cooling factor to enable heat transfer computations. By way of an alternative non-limiting example, if it is impractical to affix a tag 10 to a refrigerant unit, the tag on the container C1 that holds the refrigerant unit may additionally store properties of an added refrigerant unit(s).

By way of a further non-limiting example, there may be a need to increase the insulation (R) value for the internal environment of a storage and/or shipping container C1. An additional insulator unit I1 shown in FIG. 1 may be incorporated (e.g., polystyrene foam, etc.). The insulator unit I1 is provided with a tag 10 that stores Characteristics or attributes preferably including:
Insulator unit details (manufacturer, materials, etc.)
Exterior and interior dimensions of the insulator unit (length, width, height, mass, weight)
Insulation value (R) for heat-transfer computations.
   Alternatively, the insulator may be considered an additional container within the storage and/or shipping container C1 and modeled as such. Furthermore, if it is not practical to affix a tag 10 to the insulator unit I1, the tag 10 on the storage and/or shipping container C1 that houses the insulator unit may store the Characteristics or attributes of an added insulator unit.

For the purposes of understanding the subject matter of the present invention, a container may be defined as a bounded enclosure that is used for the storage (e.g., a refrigerator) of products or items and/or for the transport (e.g., shipping) of products or items. When storing and shipping products or items, the product or item itself may be packaged in a container that is in turn packaged in one or more larger containers. This container of containers model results in a Russian Doll configuration. The innermost product's or item's environment is affected by the surrounding container's or containers' environment(s). Every product or item has certain environmental requirements that influence what type of surrounding container(s) can be used to store the product or item or ship the product or item to a destination. When simply stored, the combination of the various containers encapsulating the product or item is referred to as a “storage container.” If the product or item that is shipped requires a refrigerated environment, for example, the product or item is placed in a refrigerated container that provides refrigerant and may provide additional insulation intended to maintain the product or item within the specified temperature range during shipment. When transport is involved, the combination of the various containers encapsulating the product or item is referred to as a “shipping container.”

By way of a particular non-limiting example, each container encapsulating a product or item may include a sensor 12. If a sensor 12 is not placed within a particular container, a sensor may be placed in an enclosing container for that container to enable computation of an adjusted expiration date of a contained product or item. The purpose of the sensor 12 is to continuously measure (and preferably record) the environmental conditions of the container with which the sensor is associated.

By way of a non-limiting example in accordance with the present invention, self-validation of a product or item is provided. Self-validation during storage of a product or item is to determine that a particular container or nesting of containers for a product or item configured as a storage container is sufficient to maintain environmental requirements of the contained product(s) or item(s) for storage under environmental conditions anticipated to be experienced during storage.

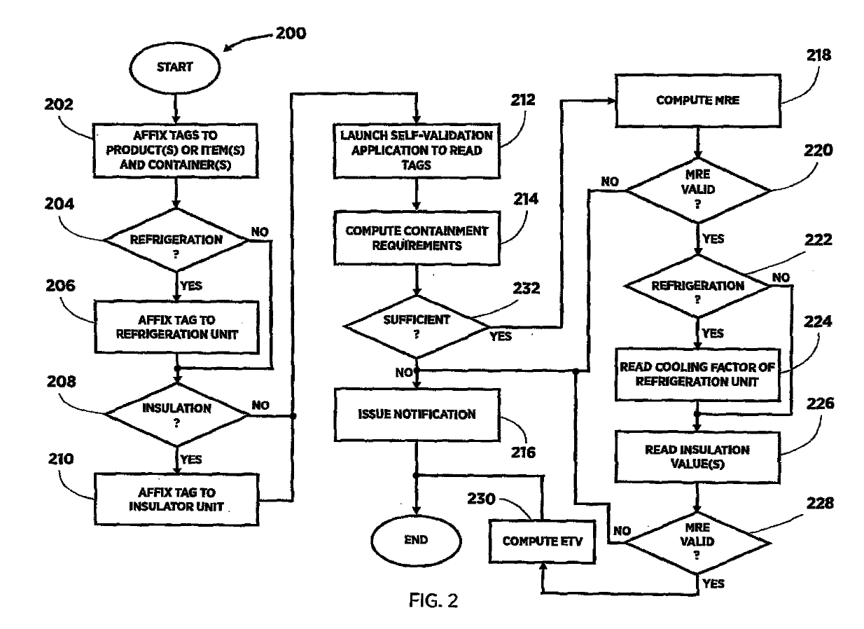

By way of a non-limiting example in accordance with the present invention, a method 200 illustrated in FIG. 2 is provided for self-validation of the compatibility of product(s) or item(s) with container(s) in which they are to be stored and/or shipped to assess whether a particular contemplated nesting of product(s) or item(s) and container(s) can be expected to satisfy the environmental requirements of the product(s) or item(s) during storage and/or shipment. To self-validate the compatibility of products or items P1 and P2 with the container C1 shown in FIG. 1, tags 10 are affixed to the products or items P1 and P2 and to the container C1, as indicated by the numeral 202. If the products or items P1 and P2 require refrigeration during shipment, as indicated by the numeral 204, a tag 10 is affixed to a refrigerant unit R1 to be placed in the container C1, as indicated by the numeral 206. Also, if additional insulation is needed, as indicated by the numeral 208, a tag 10 is affixed to an insulator unit I1 to be placed in the container C1, as indicated by the numeral 210. A self-validating software application is then launched to read all the tags 10 and associates them together with the self-validation Service, as indicated by the numeral 212.

The self-validating software application then computes containment requirements based on the dimensions of products or items P1 and P2, as well as the dimensions of the refrigerant unit R1 and/or insulator unit I1 if refrigeration and/or additional insulation is contemplated. Products or items P1 and P2 must be smaller than the container C1 to be contained by the container C1. If refrigeration is required, the refrigerant unit R1 similarly must be smaller than the container C1 to be contained by the container C1. Also, if needed, the insulator unit I1 similarly must be smaller than the container C1 to be contained by the container C1. Based on the size parameters, products or items P1 and P2 are not attributed to be a container and thus cannot contain a refrigerant unit R1 or insulator unit I1. In this way the combined size of products or items P1 and P2, as well as any refrigerant unit R1 and/or insulator unit I1, can be computed to determine whether they can all be contained in the container C1, as indicated by the numeral 214.

Bluetooth Low Energy provides a coarse method of calculating distances between broadcasting transmitters. In accordance with one non-limiting example, the distances are used to compute the containment requirements based on the tag transmissions from the products or items P1 and P2, as well as any contemplated refrigerant unit R1 and/or insulator unit I1. This also enables multiple packaging personnel to work in a small area and not interfere with each other.

If the container C1 does not meet the containment requirements, as indicated by the numeral 232, the self-validating software application issues a notification, as indicated by the numeral 216. On the other hand, if the containment requirements are satisfied, the self-validating software application also reads the environmental requirements of products or items P1 and P2 and computes a Most Restrictive Environment (MRE) by merging the environmental requirements of the products or items P1 and P2, as indicated by the numeral 218. If the self-validating software application determines that products or items P1 and P2 to be placed in the container C1 have divergent environmental requirements, as indicated by the numeral 220, the self-validating software application issues a notification, as indicated by the numeral 216. For example, if the product or item P1 has a temperature requirement that it not be exposed to temperatures below 2° C. for more than 15 minutes and the product or item P2 has a temperature requirement that it not be exposed to temperatures above −20° C. for more 15 minutes, the products or items P1 and P2 are considered to have divergent environmental requirements and not compatible for storage or shipment together.

If the products or items P1 and P2 are compatible for storage or shipment together, and refrigeration is required, as determined by the numeral 222, the self-validating software application then reads the cooling factor of the refrigerant unit R1, as indicated by the numeral 224. The self-validating software application also reads the insulation value of the container C1 and any additional insulator unit I1, as indicated by the numeral 226, and then determines whether the MRE for the products or items P1 and P2 to be contained in the container C1 is satisfied, as indicated by the numeral 228, and preferably computes an Estimated Time of Validity (ETV) should the container C1 be inside a container kept at room temperature (i.e., 20° C.), as indicated by the numeral 230. Additionally, if the MRE is satisfied, the start time, ETV, and Characteristics or attributes of the contained objects (products or items P1 and P2, as well as refrigerant unit R1, and insulator unit I1 when required) are preferably recorded in a sensor 12 affixed to the container C1.

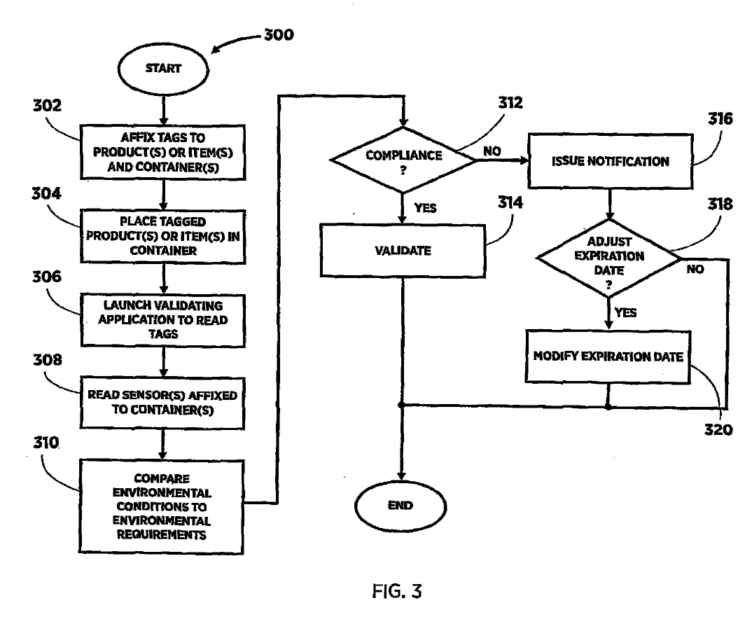

To validate a contained product or item during storage, by way of a non-limiting example in accordance with the present invention, a method 300 illustrated in FIG. 3 is provided in which tags 10 are affixed to the products or items P1 and P2 and a sensor 12 is affixed to storage container C1 shown in FIG. 1, as indicated by the numeral 302. The products or items P1 and P2 are then placed into the storage container C1, as indicated by the numeral 304. A validating software application which may be embedded in the sensor 10 is launched to read the tags 10 of the products or items P1 and P2 and associates them together with the validation Service, as indicated by the numeral 306. The sensor 12 present in the storage container C1 is also read by the validating software application during storage of the products or items P1 and P2, as indicated by the numeral 308. The validating software application measures and preferably records the measured values of the environmental conditions in the storage container C1. The validating software application compares the measured values of the environmental conditions in the container C1 to the environmental requirements of the tagged products or items P1 and P2, as indicated by the numeral 310. If the validating software application determines that the measured environmental conditions are maintained within the range(s) of the environmental requirements for the products or items P1 and P2, as indicated by the numeral 312, then compliant storage of the products or items P1 and P2 is validated, as indicated by the numeral 314. On the other hand, if, for example, a product or item has an environmental requirement that the storage temperature not dip below 2° C. for more than 15 minutes but it is placed in a storage container C1 consisting of a freezer, the validating software application determines from the sensor measurements that the product or item has likely been destroyed (invalid) due to storage in the freezer. If that is the case, the validating software application issues a notification, as indicated by the numeral 316.

Either on a recurring basis or when a product or item is removed from a storage container, the validating software application may also include code segments to determine whether to adjust the expiration date of the product or item based on any excursions of the measured environmental conditions that have occurred within the container compared to the environmental requirements of that product or item, as indicated by the numeral 318. If so, the validating software application modifies the expiration date, as indicated by the numeral 320.

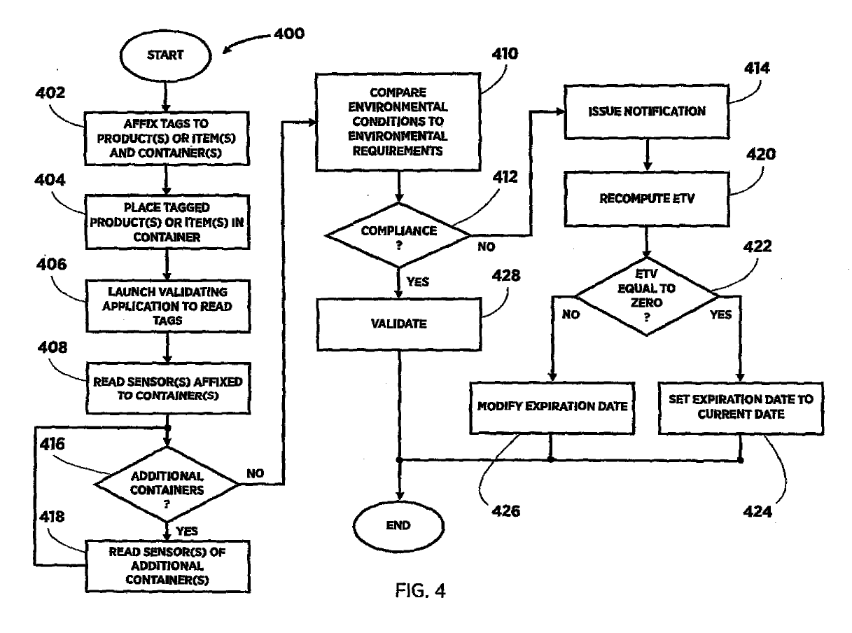

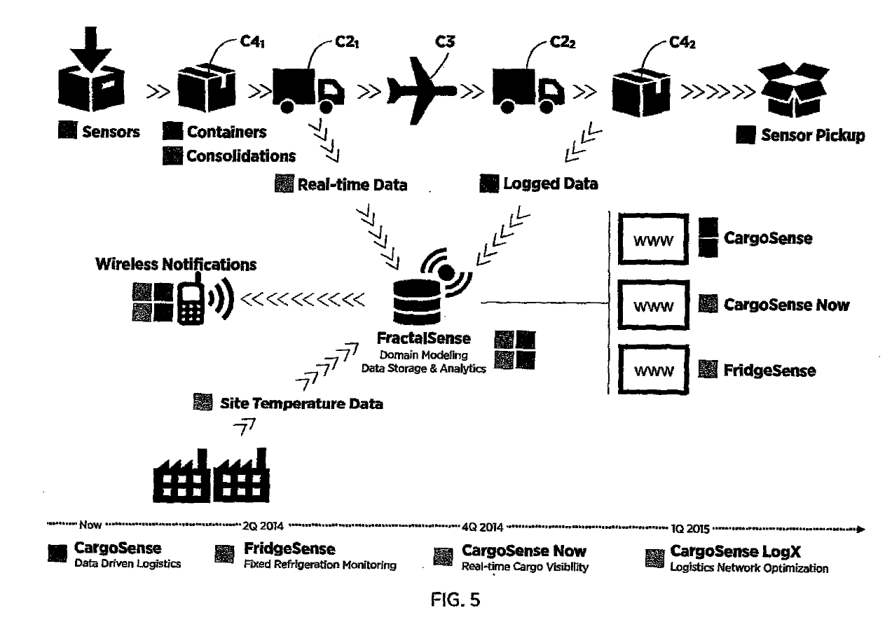

By way of a further non-limiting example in accordance with the preset invention, a method 400 shown in FIG. 4 is provided for validation of a shipped product or item in which tags 10 are affixed to products or items P1 and P2 and a sensor 12 is affixed to shipping container C1 shown in FIG. 1, as indicated by the numeral 402. The products or items P1 and P2 are then placed into the shipping container C1, as indicated by the numeral 404. A validating software application which may be embedded in the sensor 12 is launched to read the tags 10 of the products or items P1 and P2 and associates them together with the validation Service, as indicated by the numeral 406. The sensor 12 present in the shipping container C1 is also read by the validating software application in preparation for the shipment of the products or items P1 and P2, as indicated by the numeral 408. The validating software application measures and preferably records the measured values of the environmental conditions in the shipping container C1. The validating software application compares the measured values of the environmental conditions in the shipping container C1 to the environmental requirements of the tagged products or items P1 and P2, as indicated by the numeral 410. As indicated by the numeral 412, the validating software application monitors the measured environmental conditions and determines whether the measured environmental conditions are within the range(s) of the environmental requirements for the contained products or items P1 and P2 in the ambient environment C4₁ shown in FIG. 5. If the measured environmental conditions lie outside the range(s) of the environmental requirements for the products or items P1 and P2 while awaiting shipment, the validating software application issues a notification, as indicated by the numeral 414 shown in FIG. 4.

As shown in FIG. 5, during shipment of the products or items P1 and P2 in the shipping container C1, the container C1 may be placed into other containers such as a truck C2₁, an airplane C3, another truck C2₂, and another ambient environment C4₂ following shipment. When a shipping container C1 is placed in another container, the tag 10 of that other container, for example, the truck C2₁, is read by the validating software application, as indicated by the numeral 418 shown in FIG. 4, and recorded by the sensor 12 of the shipping container C1. Thus, the measurements of environmental conditions by the sensor 12 of the shipping container C1 provide time-stamped logs of containment within the containers C2₁, C3, C2₂, and C4₂.

The outer container such as the truck C2₁ also preferably has a sensor 12 affixed to the interior of cargo hold of the truck. The sensor 12 associated to the truck C2₁ is read by the validating software application, as indicated by the numeral 410. The validating software application then determines whether or not there is compliance with the environmental requirements for the products or items P1 and P2 during shipment, as indicated by the numeral 412. If not, the validating software application issues a notification, as indicated by the numeral 414, and recomputes the ETV based on the interior environment of the truck C2₁, as indicated by the numeral 420. For example, if the truck C2₁ were a refrigerated truck and the temperature were a low enough temperature to match the temperature of a refrigerant unit R1 placed in the container C1, the ETV may be extended (no time passed). On the other hand, if the temperature were above the temperature used to previously compute the value of the ETV, the ETV is reduced (more time passed than clock time).

Similarly, when the products or items P1 and P2 are transferred out of the truck C2₁ into another container such as the cargo hold of the airplane C3, the validating software application reads the sensor 12 in the cargo hold of the airplane C3, as indicated by the numeral 418, and may update the ETV, as indicated by the numeral 420. By way of a further non-limiting example, the validating software application may periodically read the sensor 12 in the cargo hold of the airplane C3 and recompute the ETV based on the values of the readings over time.

In this way, the products or items P1 and P2 contained in the shipping container C1 may be continuously validated along a logistics network. If the ETV of the products or items P1 and P2 is reduced to zero, as indicated by the numeral 422, the expiration date of the products or items P1 and P2 is set to the current date indicating that the expiration date has occurred, as indicated by the numeral 424. If, during shipment, any excursions occur that affects the expiration date of products or items P1 and P2, the validating software application updates the expiration date of the products or items P1 and P2, as indicated by the numeral 426. Finally, if compliance with the environmental requirements of the products or items P1 and P2 has been satisfied during shipment, the shipment of the products or items P1 and P2 is validated, as indicated by the numeral 428.

By way of another non-limiting example in accordance with the present invention, correlating data may be used to predict the ETV. Historic data for a type of container (container C1, etc.) that has contained shipments in the past can be used by the validating software application to more accurately compute an ETV for a particular shipping container. Additionally, if sufficient data on potential routes (truck, train, airline, ship, etc.) were available at the point of shipment, and the validating software application enables entry of a destination address, the ETV may be used to compute routes that the shipping container may travel with a higher probability that the shipped products will remain valid. This becomes even more accurate if the predicted environments (e.g., weather conditions) for the points on a route were federated and utilized to select the choice of route. The cost associated with the route may also be included as another factor in the computation to determine the cost associated with route along with and an associated percentage expectation of shipment validity.

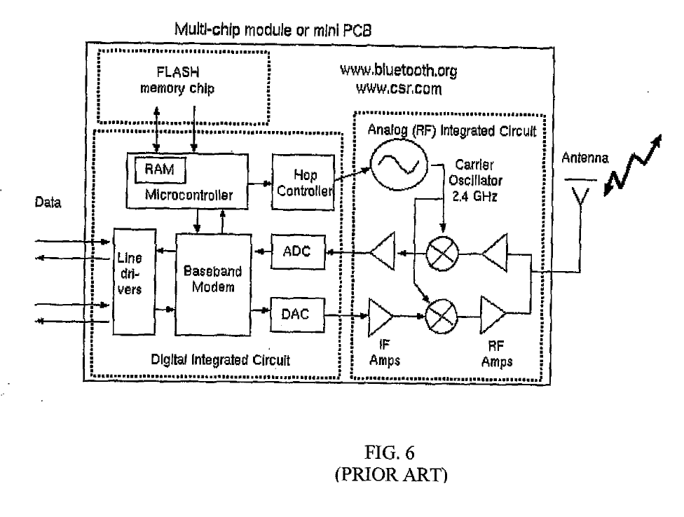

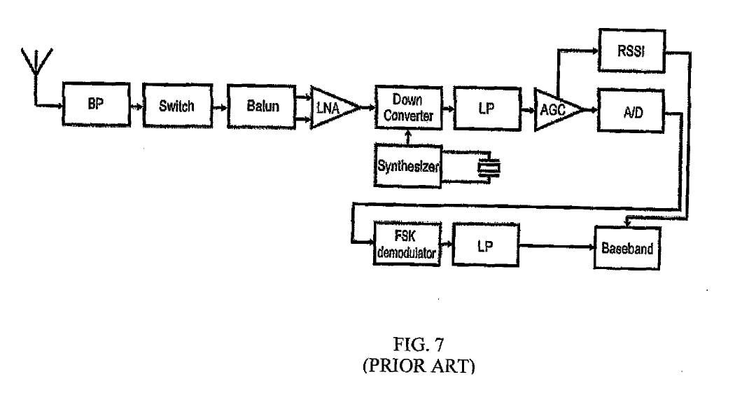

FIG. 6 is a block diagram of a conventional Bluetooth radio transmitter which may be used to implement the tag 10 and sensor 12. FIG. 7 is a block diagram of a conventional digital Bluetooth receiver which may be incorporated into an external device to receive the data transmitted by the Bluetooth radio transmitter shown in FIG. 6.

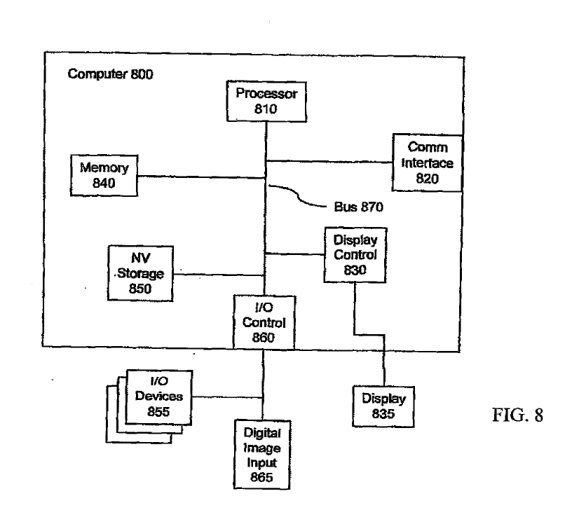

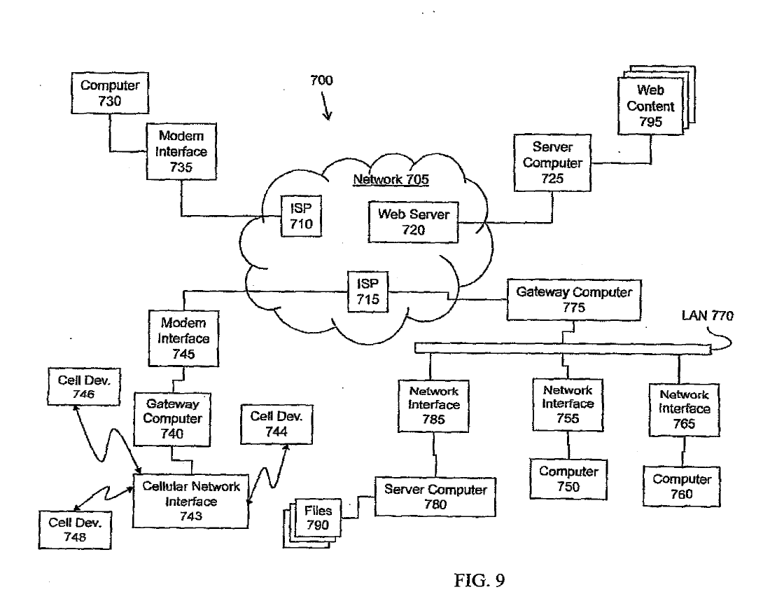

FIG. 8 shows one example of an external device that may be used to receive data transmitted by the tags 10 and sensors 12 to monitor and/or receive notifications regarding compliance with environmental requirements of products or items being stored and/or shipped. Such a device can be also used to perform many functions depending on implementation, such as office software functions, network (e.g., internet) access, and communication functions, user interface functions, telephone communications, two-way pager communications, personal organizing, or similar functions. The system 800 of FIG. 8 may also be used to implement other devices such as a personal computer, network computer, or other similar systems shown in FIG. 9.

The computer system 800 interfaces to external systems through the communications interface 820. The communications interface 820 comprises a digital Bluetooth receiver such as the receiver shown in FIG. 7. The communications interface 820 may also comprise a radio interface for communication with a cellular network to receive notifications, for example, SMS messages shown in FIG. 5, and may also include some form of cabled interface for use with an immediately available personal computer. In a two-way pager, the communications interface 820 is typically a radio interface for communication with a data transmission network, but may similarly include a cabled or cradled interface as well. In a personal digital assistant, communications interface 820 typically includes a cradled or cabled interface, and may also include some form of radio interface such as a 802.11 interface or a cellular radio interface, for example. Conventional computer systems often use an Ethernet connection to a network or a modem connection to the Internet, for example.

The computer system 800 includes a processor 810, which can be a conventional microprocessor such as an Intel Pentium microprocessor, a Texas Instruments digital signal processor, or some combination of the various types or processors. Note that processor 810 and the other components can represent single or multiple components of the same type. Memory 840 is coupled to the processor 810 by a bus 870. Memory 840 may be dynamic random access memory (DRAM) and can also include static ram (SRAM), or may include FLASH EEPROM, too. A bus 870 may also be included to couple the processor 810 to the memory 840, and also to non-volatile storage 850, to display controller 830, and to an input/output (I/O) controller 860. Note that the display controller 830 and I/O controller 860 may be integrated together, and the display may also provide input.

The display controller 830 controls in the conventional manner a display on a display device 835 which typically is a liquid crystal display (LCD) or similar flat-panel, small form factor display. The input/output devices 855 can include a keyboard, or stylus and touch-screen, and may sometimes be extended to include disk drives, printers, a scanner, and other input and output devices, including a mouse or other pointing device. The display controller 830 and the I/O controller 860 can be implemented with conventional well-known technology. A digital image input device 865 may be a digital camera which is coupled to an I/O controller 860 in order to allow images from the digital camera to be input into the device 800.

The non-volatile storage 850 is often a FLASH memory or read-only memory, or some combination of the two. A magnetic hard disk, an optical disk, or another form of storage for large amounts of data may also be used in some examples, although the form factors for such devices typically preclude installation as a permanent component of the device 800. Rather, a mass storage device on another computer is typically used in conjunction with the more limited storage of the device 800. Some of this data is often written, by a direct memory access process, into memory 840 during execution of software in the device 800. Persons of skill in the art will immediately recognize that the terms “machine-readable medium” or “computer-readable medium” includes any type of storage device that is accessible by the processor 810.

The device 800 is one example of many possible devices which have different architectures. For example, devices based on an Intel microprocessor often have multiple buses, one of which can be an input/output (I/O) bus for the peripherals and one that directly connects the processor 810 and the memory 840 (often referred to as a memory bus). The buses are connected together through bridge components that perform any necessary translation due to differing bus protocols.

In addition, the device 800 is controlled by operating system software which includes a file management system, such as a disk operating system, which is part of the operating system software. One example of an operating system software with its associated file management system software is the family of operating systems known as Windows CE® and Windows® from Microsoft Corporation of Redmond, Wash., and their associated file management systems. Another example of an operating system software with its associated file management system software is the Apple® iOS® operating system and its associated file management system. The file management system is typically stored in the non-volatile storage 850 and causes the processor 810 to execute the various acts required by the operating system to input and output data and to store data in memory, including storing files on the non-volatile storage 850. Other operating systems may be provided by makers of devices, and those operating systems typically will have device-specific features which are not part of similar operating systems on similar devices. Similarly, WindowsCE® or iOS® operating systems may be adapted to specific devices for specific device capabilities.

Device 800 may be integrated onto a single chip or set of chips in some examples, and typically is fitted into a small form factor for use as a personal device. Thus, it is not uncommon for a processor, bus, onboard memory, and display/I-O controllers to all be integrated onto a single chip. Alternatively, functions may be split into several chips with point-to-point interconnection, causing the bus to be logically apparent but not physically obvious from inspection of either the actual device or related schematics.

FIG. 9 shows several computer systems that are coupled together through a network 705, such as the Internet, along with a cellular or other wireless network and related cellular or other wireless devices which may be used to implement the comprehensive data management system shown in FIG. 5. The term “Internet” as used herein refers to a network of networks which uses certain protocols, such as the TCP/IP protocol, and possibly other protocols such as the hypertext transfer protocol (HTTP) for hypertext markup language (HTML) documents that make up the world wide web (web). The physical connections of the internet and the protocols and communication procedures of the internet are well known to persons of skill in the art.

Access to the internet 705 is typically provided by Internet service providers (ISP), such as the ISPs 710 and 715. Users on client systems, such as client computer systems 730, 750, and 760 obtain access to the internet through the internet service providers, such as ISPs 710 and 715. Access to the internet allows users of the client computer systems to exchange information, receive and send e-mails, and view documents, such as documents which have been prepared in the HTML format. These documents are often provided by web servers, such as web server 720 which is considered to be “on” the internet. Often these web servers are provided by the ISPs, such as ISP 710, although a computer system can be set up and connected to the internet without that system also being an ISP.

The web server 720 is typically at least one computer system which operates as a server computer system and is configured to operate with the protocols of the world wide web and is coupled to the internet. Optionally, the web server 720 can be part of an ISP which provides access to the internet for client systems. The web server 720 is shown coupled to the server computer system 725 which itself is coupled to web content 795, which can be considered a form of a media database. While two computer systems 720 and 725 are shown in FIG. 9, the web server system 720 and the server computer system 725 can be one computer system having different software components providing the web server functionality and the server functionality provided by the server computer system 725 which will be described further below.

Cellular network interface 743 provides an interface between a cellular network and corresponding cellular devices 744, 746, and 748 on one side, and network 705 on the other side. Thus, cellular devices 744, 746, and 748, which may be personal devices including cellular telephones, two-way pagers, personal digital assistants, or other similar devices, may connect with network 705 and exchange information such as e-mail, content, or HTTP-formatted data, for example, or SMS messages comprising notifications shown in FIG. 5.

Cellular network interface 743 is representative of wireless networking in general. In various examples, such an interface may also be implemented as a wireless interface such as a Bluetooth interface to receive data from tags 10 and sensors 12. The cellular network interface may also include an IEEE 802.11 interface or some other form of wireless network. Similarly, devices such as devices 744, 746, and 748 may be implemented to communicate among themselves via the Bluetooth or 802.11 protocols, for example. Other dedicated wireless networks may also be implemented in a similar fashion.

Cellular network interface 743 is coupled to computer 740, which communicates with network 705 through modem interface 745. Computer 740 may be a personal computer, server computer, or the like, and serves as a gateway. Thus, computer 740 may be similar to client computers 750 and 760 or to gateway computer 775, for example. Software comprising code segments or content may then be uploaded or downloaded through the connection provided by interface 743, computer 740, and modem 745.

Client computer systems 730, 750, and 760 can each, with the appropriate web browsing software, view HTML pages provided by the web server 720. The ISP 710 provides Internet connectivity to the client computer system 730 through the modem interface 735 which can be considered part of the client computer system 730. The client computer system can be a personal computer system, a network computer, or other such computer system.

Similarly, the ISP 715 provides Internet connectivity for client systems 750 and 760, although as shown in FIG. 9, the connections are not the same as for more directly connected computer systems. Client computer systems 750 and 760 are part of a LAN coupled through a gateway computer 775. While FIG. 9 shows the interfaces 735 and 745 generically as a “modem,” each of these interfaces can be an analog modem, isdn modem, cable modem, satellite transmission interface (e.g., “direct PC”), or other interfaces for coupling a computer system to other computer systems.

Client computer systems 750 and 760 are coupled to a LAN 770 through network interfaces 755 and 765, which can be Ethernet network or other network interfaces. The LAN 770 is also coupled to a gateway computer system 775 which can provide firewall and other Internet-related services for the local area network. This gateway computer system 775 is coupled to the ISP 715 to provide Internet connectivity to the client computer systems 750 and 760. The gateway computer system 775 can be a conventional server computer system. Also, the web server system 720 can be a conventional server computer system. Alternatively, a server computer system 780 can be directly coupled to the LAN 770 through a network interface 785 to provide files 790 and other services to the clients 750 and 760, without the need to connect to the internet through the gateway system 775.

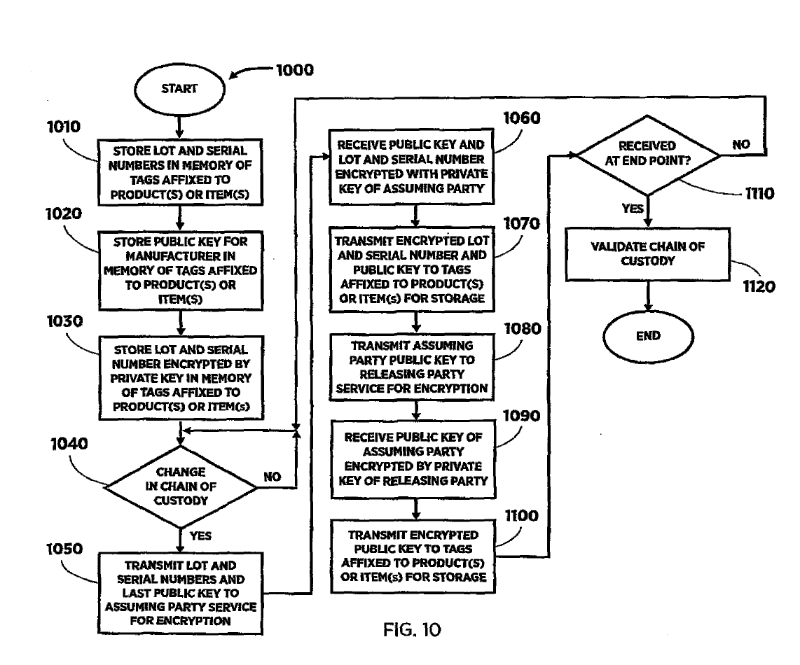

By way of a further non-limiting example in accordance with the present invention, a method 1000 for validation of a chain of custody for products or items P1 and P2 may be provided, as illustrated in FIG. 10. Identifying information is stored in the memory of the tag 10 for the product(s) or item(s) P1 and P2 and comprises a lot number and serial number(s), for example, as required by the DQSA, as indicated by the numeral 1010. Additionally, a public key (of a public/private key pair) of the manufacturer is stored in the memory of the tag 10 for the product(s) or item(s) P1 and P2, as indicated by the numeral 1020, and is accessible to be read. The private key of the manufacturer is used to encrypt the lot and serial number(s) and store the encrypted data in the memory of the tag 10, as indicated by the number 1030.

During shipment, when a custody transfer occurs, as indicated by the numeral 1040 shown in FIG. 10, the original lot/serial number(s) are transmitted by a device operated by the assuming party from the tag 10 for the product(s) or item(s) P1 and P2 in addition to the last custodian's public key to a server for the assuming party, as indicated by the numeral 1050. The assuming party service is required to encrypt the lot and serial number(s) with their private key (of a public/private key pair), and the encrypted lot and serial number(s) and the assuming party's public key are transmitted back to the device operated by the assuming party, as indicated by the numeral 1060, which updates the tag 10 for the product(s) or item(s) P1 and P2 with a change of custody Assuming Event (public key plus encrypted lot/serial number(s)), as indicated by the numeral 1070. Additionally, a device operated by the releasing party transmits to a server for the releasing party the public key of the assuming party from the tag 10 for the product(s) or item(s) P1 and P2, as indicated by the numeral 1080. The releasing party service is required to encrypt with their private key (of a public/private key pair) the public key of the assuming party and transmit that encrypted public key back to the device operated by the releasing party, as indicated by the numeral 1090, which updates the tag 10 for the product(s) or item(s) P1 and P2 with a change of custody Releasing Event (encrypted public key of assuming party), as indicated by the numeral 1100. Each party that accepts a transfer of custody performs this procedure. Upon receipt at the end point (e.g., a pharmacy, hospital, doctor's office, etc.), as indicated by the numeral 1110, the sequence of change of custody events can be analyzed to validate that the product(s) or item(s) P1 and P2 has been in a proper chain of custody throughout the supply chain process, as indicated by the numeral 1120. Storing the sequence of chain of custody events in the memory of the tag 10 for the product(s) or item(s) P1 and P2 enables validation of chain of custody without need of a central database.

While the foregoing description has been with reference to particular examples of the present invention, it will be appreciated by those skilled in the art that changes in these examples may be made without departing from the principles and spirit of the invention. Accordingly, the scope of the present invention can only be ascertained with reference to the appended claims.

What is claimed is:

1. A system for authentication and/or validation of environmentally sensitive products or items, comprising:
a tag affixed to a product or item to enable identifying information comprising product or item expiration date and other manufacturer specific data and physical specifications and environmental specifications that affect the expiration date for the product or item to be associated to the product or item, wherein the tag is an electronic device comprising memory to store the identifying information and comprises a transmitter coupled to the memory; and
a device coupled to the tag by wireless transmission to receive the identifying information, physical specifications, and environmental specifications, so that provisions for storage or shipment of the tagged product or item are provided to validate compliance with authentication requirements and the environmental specifications.

2. A system as recited in claim 1 wherein the tag comprises a Bluetooth Low Energy (BLE) device.

3. A system as recited in claim 1, further comprising a tag affixed to a storage or shipping container for the tagged product or item having specifications for dimensions and thermal properties of the storage or shipping container, wherein the tags communicate with each other by wireless transmission, so that provisions for storage or shipment of the tagged product or item are compatible with the storage or shipping container to validate compliance with the requirements of the environmental specifications for the product or item being stored or shipped.

4. A system as recited in claim 3 wherein the tags comprise Bluetooth Low Energy (BLE) devices.

5. A system as recited in claim 3, further comprising at least one of a refrigerant unit and an insulator unit combined with the storage or shipping container, wherein a tag is affixed to the refrigerant unit or insulator unit having specifications for thermal properties and wherein the tags communicate with each other by wireless transmission, so that provisions for storage or shipment of the tagged product or item are compatible with the storage or shipping container incorporating the refrigerant unit or insulator unit to validate compliance with the requirements of the environmental specifications for the product or item being stored or shipped.

6. A system as recited in claim 5 wherein the tags comprise Bluetooth Low Energy (BLE) devices.

7. A system as recited in claim 3, further comprising a sensor affixed to at least one of the product or item and the storage or shipping container to measure environmental conditions during storage or shipment, wherein the sensor comprises a transmitter to communicate by wireless transmission to the product or item tag and memory to store the measurements and wherein the sensor measures and monitors the environmental conditions to validate whether or not the environmental conditions encountered during storage or shipment of the product or item are within a specified range of environmental specifications stored in the memory of the tag for the product or item being stored or shipped.

8. A system as recited in claim 7 wherein the sensor comprises a Bluetooth Low Energy (BLE) device.

9. A system as recited in claim 7 wherein the sensor continuously measures and communicates and wirelessly transmits the environmental conditions to an external device to update or analyze the measured environmental conditions throughout a supply chain from manufacturing to distribution.

10. A system as recited in claim 7 wherein the sensor detects, during storage or shipment, that the sensor measurements deviate from the product or item environmental specifications and calculates the impact to the expiration date on the product or item and wirelessly updates the expiration date and/or an estimated time of validity stored in the memory of the product or item tag.

11. A system as recited in claim 5 wherein a device coupled to the product or item tag, the container tag, and the insulator or refrigerant unit tag by wireless transmission calculates the estimated time that the environmental specifications will be maintained within the container based on the thermal properties of the insulator or refrigerant unit and container and an estimated external environmental condition surrounding the container and updates the estimated time of validity stored in the memory of the product or item tag.

12. A system as recited in claim 11 wherein the device comprises a Bluetooth Low Energy (BLE) device.

13. A system as recited in claim 5 wherein a plurality of products or items having tags are in the container and the device collects minimum and maximum values of all environmental specifications from the product or item tags by wireless transmission within the container and combines those values into a set which forms a most restrictive environment and then validates that the most restrictive environment when combined with the insulator or refrigeration unit tag specifications collected by wireless transmission will maintain a proper environment during storage or shipment and issues a notification if the supplied insulation and/or refrigerant is insufficient.

14. A system as recited in claim 7, further comprising a second sensor affixed outside of the container to measure environmental conditions surrounding the container during storage or shipment, wherein the second sensor comprises a transmitter to communicate wirelessly to the sensor within the container the external measurements which impact the estimated time of validity, and the sensor within the container updates the product or item tag to store a new estimated time of validity.

15. A system as recited in claim 14 wherein the second sensor comprises a Bluetooth Low Energy (BLE) device.

16. A system as recited in claim 3 wherein a plurality of products or items having tags are in the container and a device collects minimum and maximum values of all environmental specifications from the product or item tags by wireless transmission within the container and calculates if the environmental specifications are compatible with one another and, if not, issues a notification that the products or items cannot be stored or shipped together.

17. A system as recited in claim 16 wherein the device comprises a Bluetooth Low Energy (BLE) device.

18. A system as recited in claim 3 wherein a plurality of products or items having tags are to be stored or shipped in the container and a device collects physical specifications from the product or item tags by wireless transmission and the physical specifications of the container tag collected by wireless transmission and calculates if the combined physical size of the products or items will fit within the physical dimensions of the container and, if not, issues a notification that the combined products or items cannot be stored or shipped within the container.

19. A system as recited in claim 18 wherein the device comprises a Bluetooth Low Energy (BLE) device.

20. A system as recited in claim 4 where the Bluetooth Low Energy (BLE) device uses the Bluetooth Low Energy (BLE) RSSI signal strength received from the product or item and container tags to calculate the rough distances between itself and those tags to automatically isolate a set of product or item and container tags near the device and ignore product or item and container tags that are farther away allowing simultaneous build out of products or items and containers in a limited area by multiple personnel.

21. A system as recited in claim 5 wherein a device coupled to the product or item tag, the container tag, and the insulator or refrigerant unit tag by wireless transmission calculates the estimated time that the environmental specifications will be maintained within the container based on the thermal properties of the insulator or refrigerant unit and container and an estimated external environmental condition surrounding the container and updates the estimated time of validity stored in the memory of the product or item tag.

22. A system as recited in claim 11 wherein the device uses correlating data based on historically collected measurements of container performance to better estimate and update the estimated time of validity stored in the memory of the product or item tag.

23. A system as recited in claim 11 wherein the device uses correlating data based on historically collected measurements of external environments that the container could pass through along multiple routes and each computed estimated time of validity to present the optimal route to ship the container to ensure validity.

24. A system as recited in claim 1 wherein the product or item tag identifying information comprises a manufacturer's lot number and serial number, a public key of a public/private key pair (as used in public key cryptography) which is a known public key of the manufacturer, and an encrypted combination of the lot and serial number by the private key of the public/private key pair which acts as cryptographic proof of authenticity that the manufacturer originated the product or item tag.

25. A system as recited in claim 24 wherein a device used by a party assuming custody, at a point of transfer of custody of the product or item associated with the product or item tag, reads the encrypted combination of the last stored lot and serial number and public key by wireless transmission and transfers those data items to a service used by the assuming party in a custody transfer, and the service encrypts the lot and serial number with the assuming party's private key of a public/private key pair (as used in public key cryptography) and returns the assuming party's public key and the encrypted lot and serial number to the device and the device writes the encrypted lot and serial number and public key of the assuming party into the product or item tag associated with the product or item through wireless transmission.

26. A system as recited in claim 25 wherein a device used by a party releasing custody, at the point of the transfer of custody of a product or item associated with the product or item tag, reads the assuming party's public key by wireless transmission and transfers that data item to a service used by the releasing party in a custody transfer and the service of the releasing party encrypts the public key of the assuming party with the releasing party's private key of a public/private key pair (as used in public key cryptography) and returns the encrypted assuming party's public key to the device and the device writes the encrypted assuming party's public key into the product or item tag associated with the product or item through wireless transmission completing the transfer of custody.

27. A system as recited in claim 26 wherein a device, at an end point of transfer of custody of the product or item associated with the product or item tag, reads all stored encrypted combinations of lot and serial numbers and public keys and encrypted public keys by wireless transmission and decrypts each combination of lot and serial number with a corresponding public key and validates the public key against the encrypted public key using the public key from each prior custody event and then progresses to validate the transfers until arriving at the known public key of the manufacturer which validates chain of custody and the authenticity of the product or item tag associated with the product or item and notifies a user of the device of the validation.
